(19) United States
(12) Patent Application Publication
(10) Pub. No.: US 2008/0203861 A1
(43) Pub. Date: Aug. 28, 2008

(54) Hospital medication cart

(76) Inventor: Safronia R. Wingate, Indianola, MS (US)

Correspondence Address: JAMES RAY & ASSOCIATES, 2640 PITCAIRN ROAD, MONROEVILLE, PA, 15146, US

(21) Appl. No.: 12/070,446

(22) Filed: Feb. 19, 2008

Related U.S. Application Data
(60) Provisional application No. 60/902,702, filed on Feb. 22, 2007.

(51) Int. Cl. A61G 12/00; B62B 3/00

(52) U.S. Cl. 312/209; 280/47.35; 312/215; 312/290; 312/249.8

(57) ABSTRACT

In combination with a mobile medical medication cart for dispensing medications to a variety of patients, such medical treatment cart consisting of a substantially rectangular cart member having a plurality of drawers disposed on a same side of said cart, having wheels disposed at each corner of said cart and having a top surface thereon, the improvement comprises an acid resistant top surface having a cavity disposed therein. There is a three tiered step down tray for holding pre-measured medications and water. Such three tiered step down tray disposed completely within in the cavity formed in the top surface thereof. A narcotics drawer is disposed on a same side of the cart as such plurality of drawers. The narcotics drawer has a front portion that flips down and slides into the cart member and there is at least one lockable pullout bin disposed in the narcotics drawer for holding narcotic medications.

### CROSS REFERENCE TO RELATED APPLICATIONS

This application is closely related to and claims benefit from U.S. Provisional Application Ser. No. 60/902,702 filed Feb. 22, 2007.

### FIELD OF THE INVENTION

The present invention relates, in general, to a medication cart, and, more particularly, the present invention relates to a improved hospital or nursing home medication cart wherein the cart includes a three tiered step down tray for holding pre-measured individual medications and water securely so as to prevent spilling.

### BACKGROUND OF THE INVENTION

Medication carts are used to dispense medication at hospitals, nursing homes and other facilities all over the country. Although these carts are used by millions of healthcare workers, the current design can be inefficient and can increase the potential for injury to the nurse or other health care worker who uses them on a daily basis.

Thus, it would be advantageous if there were a medication cart that held the medications more securely and also had a secure narcotics drawer.

### SUMMARY OF THE INVENTION

The present invention provides in combination with a mobile medical medication cart for dispensing medications to a variety of patients. Such medical medication cart consisting of a substantially rectangular cart member having a plurality of drawers disposed on a same side of said cart, having wheels disposed at each corner of said cart and having a top portion, the improvement comprises an acid resistant top surface having a cavity disposed therein and a three tiered step down tray for holding pre-measured individual medications and water, such three tiered step down tray is disposed completely within the cavity formed in the top surface thereof. There is also a narcotics drawer that is disposed on a same side of the cart as such plurality of drawers. The narcotics drawer has a front portion that flips down and slides into the cart member and there is at least one lockable pullout bin disposed in such narcotics drawer for holding narcotic medications that is accessible when the front portion has flipped down.

### OBJECTS OF THE INVENTION

It is, therefore, one of the primary objects of the present invention to provide a mobile medication cart that includes a three tiered step down tray that is disposed within such top portion of the cart.

Another object of the present invention is to provide a mobile medication cart that includes a cavity in the top surface for holding such three tiered tray.

Still another object of the present invention is to provide a mobile medication cart that includes a lockable narcotic drawer.

Yet another object of the present invention is to provide a mobile medication cart that includes a pull out tray for writing thereupon.

Another object of the present invention is to provide a mobile medication cart that includes a disposable bin on the side of the cart for disposing needles and biohazardous waste.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a front perspective view of the mobile medication cart according to an embodiment of the invention.

FIG. 2 is a front angled perspective view of the cart shown in FIG. 1 showing the pullout tray partially pulled out.

FIG. 3 is a perspective view of the inside of the narcotics drawer showing the two lockable bins therein.

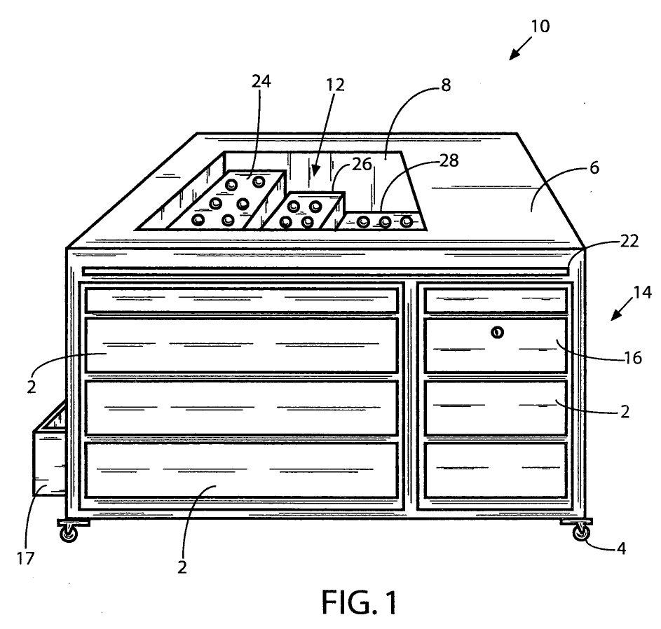

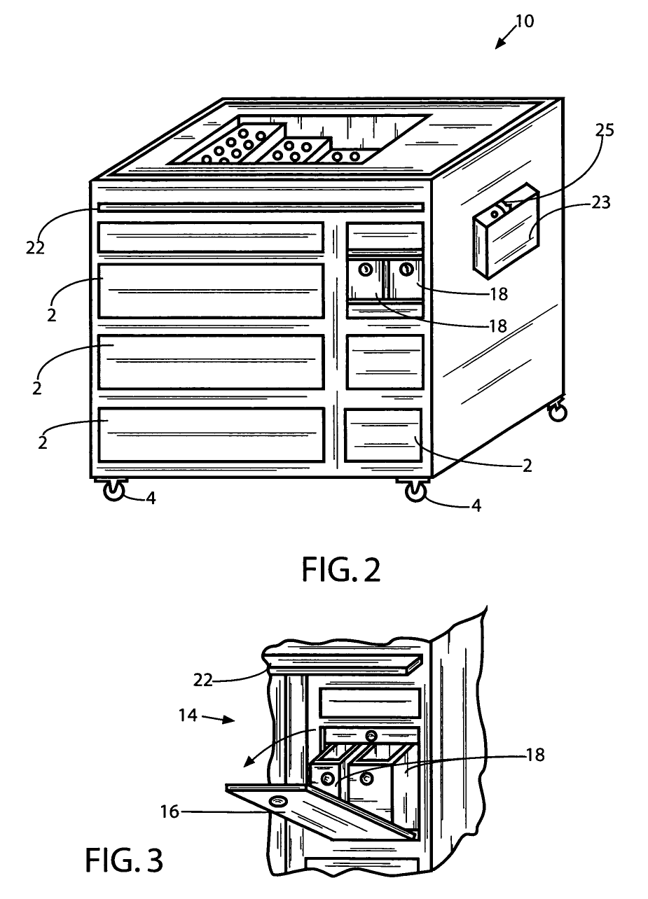

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides in combination with a mobile medical medication cart, generally designated 10, for dispensing medications to a variety of patients. Such medical medication cart 10 consisting of a substantially rectangular cart member 10 having a plurality of drawers 2 disposed on a same side of the cart 10, having wheels 4 disposed at each corner of the cart 10 and having a top portion 6, the improvement comprises an acid resistant top surface 6 having a cavity 8 disposed therein. There is a three tiered step down tray 12 for holding pre-measured individual medications and water, such three tiered step down tray 12 is disposed completely within the cavity 8 formed in the top surface 6 thereof.

A narcotics drawer 14 is disposed on a same side of the cart as such plurality of drawers. The narcotics drawer has a front portion 16 that flips down and slides into the cart member 10 and there is at least one lockable bin 18 disposed in the narcotics drawer 14 for holding narcotic medications.

Such medical medications cart 10 further includes a slide out tray 22 disposed closely adjacent and below the top portion 6 for use as a writing platform. The cart further includes a bin 23 that is engageable with a side of the cart 10 for disposal of needles and biohazardous waste material. Such bin 23 has a disposable liner 25 disposed therein. On the opposite side of the medication cart 10 is another bin 17 that is a waste bin 17 for general trash.

The top tier 24 of three tiered step down tray 12 is used to hold cups containing pills to be dispensed to patients. The middle tier 26 of the three tiered tray 12 is used for cups holding liquid medication for such patients while the bottom tier 28 of the three tiered step down tray 12 is used for holding cups containing water. As stated previously these medications are pre-measured individual medications.

It is presently preferred that such narcotics drawer 14 is between about 15 inches and 16 inches in width. As stated previously such narcotics drawer 14 has a front portion 16 that flips down and slides into the cart member 10 revealing the at least one lockable bin 18. Presently it is preferred that the at least one lockable bin 18 is a pullout bin 18. Further it is preferred that there are two lockable bins 18 disposed in the narcotics drawer 14 and that the two lockable bins 18 are pullout bins 18.

The plurality of drawers 2 are used to store supplies as necessary. These drawers are substantially 5 inches high and have a width of between about 22 and about 23 inches and are disposed on one portion of the front of the cart. The plurality of drawers 2 also includes two drawers that have substantially a similar size as the narcotics drawer 14 and are disposed below the narcotics drawer 14. These drawers are for storing liquids and house stock medications.

It should be noted that although this cart may have been referred to as a hospital medications cart it probably is even more useful in a nursing home. Further, although not shown in any of the drawing Figures it is with the concept of the invention that such cart 10 have an over all lock which would lock the entire cart.

Thus, the present invention provides an improved and more functional medication cart. Such cart is made of stainless steel, plastic or other similar, durable materials. The unit features an acid resistant top which has a cavity disposed in a portion of the top. There is a three tiered step down tray disposed in the cavity for holding pre-measured individual medications and water. The top tier contains cups with pills therein, the second or middle tier is used with plastic cups holding liquid medications and the bottom tier has cups containing water. By having the three tiered step down tray disposed within the top there is less chance for the inadvertent spills that can occur if the cart is bumped and also there is less chance of inadvertently bumping the cups while performing any of the necessary chores.

The cart further features a slide-out tray for providing a writing surface. The slide-out tray is disposed closely adjacent and below the top portion. Further, the cart has a lockable narcotics drawer. The narcotics drawer features a front portion that flips down and slides into the cart, thus, revealing the actual narcotics area. There are two lockable pullout narcotics bins in the drawer.

There is also a bin disposed on the side of the cart for disposal of used needles and other biohazardous waste material. The bin contains a disposable liner 25 therein so none of the waste is ever touched. There is also a bin 17 engageable with the opposite side of the cart an the biohazardous bin that is added for general waste material.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. In combination with a mobile medical medication cart for dispensing medications to a variety of patients, said medical medication cart consisting of a substantially rectangular cart member having a plurality of drawers disposed on a same side of said cart, having wheels disposed at each corner of said cart and having a top portion, the improvement comprising:
(a) an acid resistant top surface of said top portion having a cavity disposed therein;
(b) a three tiered step down tray for holding pre-measured individual medications and water, said three tiered step down tray disposed completely within said cavity in said top portion thereof;
(c) a narcotics drawer disposed on a same side of said cart as said plurality of drawers, said narcotics drawer having a front portion that flips down and slides into said cart; and
(d) at least one lockable bin disposed in said narcotics drawer for holding narcotic medications.

2. The cart, according to claim 1, wherein said cart further includes a slide out tray disposed closely adjacent and below said top portion for use as a writing platform.

3. The cart, according to claim 1, wherein said cart further includes a bin engageable with a side of said cart for disposal of needles and biohazardous waste material.

4. The cart, according to claim 1, wherein said narcotics drawer is between about 15 inches and 16 inches in width.

5. The cart, according to claim 1, wherein a top tier of said three tiered step down tray is used for holding cups containing pills to be dispensed to patients.

6. The cart, according to claim 1, wherein a middle tier of said three tiered step down tray is used for cups holding liquid medication for such patients.

7. The cart, according to claim 1, wherein a bottom tier of said three tiered step down tray is used for holding cups containing water.

8. The cart, according to claim 1, wherein said at least one lockable bin in said narcotics drawer is a pullout bin.

9. The cart, according to claim 8, wherein said narcotics drawer has two lockable bins.

10. The cart, according to claim 9, wherein said two lockable bins are pullout bins.

11. The cart, according to claim 1, wherein three of said plurality of drawers are used to store supplies as necessary.

12. The cart, according to claim 11, wherein said three of said plurality of drawers are substantially identical.

13. The cart, according to claim 1, wherein said three drawers are between about 22 inches and about 23 inches in width.

14. The cart, according to claim 1, wherein said three drawers are between 4½ inches and about 5½ inches in height.

15. The cart, according to claim 1, wherein said plurality of drawers also includes two drawers having substantially a similar size as said narcotics drawer and disposed below said narcotic drawer.

16. The cart, according to claim 15, wherein said two drawers of said plurality of drawers are for storing liquids and house stock medication.

17. The cart, according to claim 3, wherein said bin disposed on said side of said cart for receiving used needles and biohazardous waste has a disposable liner disposed therein.

18. The cart, according to claim 17, wherein said medication cart further includes a bin for general waste material disposed on an opposite side of said cart as said biohazardous bin.
